(19) United States
(12) Patent Application Publication
(10) Pub. No.: US 2023/0314073 A1
(43) Pub. Date: Oct. 5, 2023

(54) UNIT FOR DIRECT SORPTION DRYING AND METHODS THEREOF

(71) Applicant: Caloritum NV, Antwerpen (BE)

(72) Inventor: Wouter Ducheyne, Antwerpen (BE)

(73) Assignee: Caloritum NV, Antwerpen (BE)

(21) Appl. No.: 18/024,642

(22) PCT Filed: Sep. 8, 2021
(86) PCT No.: PCT/EP2021/074680

§ 371 Date: Mar. 3, 2023

(30) Foreign Application Priority Data
Sep. 8, 2020 (GB) 2014072.9

(51) Int. Cl. F26B 21/08; F26B 21/10

(52) U.S. Cl. CPC F26B 21/083; F26B 21/10

(57) ABSTRACT

The present invention is related to the field of industrial drying unit. The present invention provides for a unit for drying and methods for the direct sorption drying of substances such as, but not limited to, pellets, construction materials, wood, gases, pulp and paper, drying of chemicals from synthesis reactions or inorganic and organic acid production, food.

### FIELD OF THE INVENTION

The present invention is related to the field of industrial drying units. More specifically, the present invention relates to a unit for the direct sorption drying of substances such as, but not limited to, pellets, construction materials, wood, gases, pulp and paper, drying of chemicals from synthesis reactions or inorganic and organic acid production, food.

### BACKGROUND TO THE INVENTION

Drying is an important process in many industries, consisting in the removal of water or another liquid by evaporation. Drying technology is used in different industries and for different applications, such as the drying of, but not limited to, pellets, construction materials, pulp and paper, chemicals from organic or inorganic reactions, organic acid production, food and more. Several drying technologies and respective units are part of the state of the art (e.g. freeze-drying, direct drying, indirect drying, dielectric drying, sorption drying.).

Direct drying, also known as convective drying, is a technique known in the industry. One of the main advantages of direct drying is its high efficiency, which is mainly due to the close contact of the substance to be dried with hot gases e.g. hot air. Nevertheless, only the use of anoxic (non-toxic) sorption liquids can be considered for direct contact drying. Therefor halogen salts (Li—Cl; Li—Br . . . ) based liquids or toxic chemical liquids cannot be used in many processes with direct contact as there will always be a contamination—even in very small concentrations e.g. at ppm level—with the products being dried. Nevertheless, exposing a liquid sorption system in direct contact with the air to be dried, gives tremendous advantages to overcome the lousy heat transfer coefficients between air and cooling/heating medium in an indirect contact heat exchanger. Still, and besides the possible risk of contamination, a limitation with convective drying is the heat exposure which is incompatible with heat-sensitive materials.

Further, sorption drying units in the state of the art have major disadvantages, such as: 1) poor heat transfer coefficient to take out the heat from the moist air to be dried, 2) not possible to use direct contact due to contamination between the substance/product to be dried and the heat pump fluids and/or the sorption means, 3) not possible to dry moist air at high temperatures so to have a low relative humidity of the dried air to be obtained and to use to dry a substance/product.

CN105435596A describes the use of polyphosporic acid as dessicant to remove moisture from the air. A drawback of the unit described therein is that does not allow for the drying of sensible substances e.g. food. Moreover, said unit is not suitable for continuous operation.

U.S. Pat. No. 5,048,200 provides a process and apparatus for dehumidifying wet air, using an absorber with a circulating absorption liquid comprising an aqueous hygroscopic salt and heating at least a portion of the absorption liquid by indirect heat exchange. The apparatus provide in this US patent is developed for drying the wet air from a liquid ring pump used in the paper industry, wherein higher temperatures are not immediately an issue and as such not optimized for the drying of sensible substances e.g. food.

It is an object of the present invention to overcome the drawbacks of the prior art and provide for an improved drying unit providing for direct drying and sorption drying and a method of drying thereof. Specifically, it is an object of the present invention to provide for a sorption drying unit for direct drying which provides a reduced contamination of the substance to be dried by e.g. having the sorption drying process at lower vapour pressure. It is a further object of the present invention to provide for increased drying velocity and continuous operation. It is a further object of the present invention to provide for a sorption drying unit providing increased efficiency, increased drying velocity and continuous operation, even at lower temperatures.

### SUMMARY OF THE INVENTION

The present invention provides for a unit for drying. Here below, enumerated embodiments of the invention are provided.

1. A drying unit for drying a substance comprising:
a sorption unit having a first inlet adapted to receive a first stream of air having water content W₁, a first outlet adapted to exit a second stream of air having water content W₂, wherein W₂<W₁, and therefore wherein the first stream of air having water content W₁ is moist relative to said second stream of air having water content W₂, and wherein the sorption unit further comprises a second inlet adapted to receive sorption means, and a second outlet adapted to exit consumed sorption means;
sorption means contained in said sorption unit, the sorption means comprising an inorganic oxoacid and/or its salt and water,
   wherein in operation the sorption means sorb water from the first stream of air, to provide the second stream of air, therefore drying said first stream of air, and wherein the drying unit further comprises:
a first heat exchange element adapted to exchange heat with the sorption means; and
entrainment means connected to the sorption unit, wherein the entrainment means is adapted to receive the second stream of air and to separate entrained sorption means from said second stream of air, in other words, recuperating sorption means which have been consumed from the dried air

2. The drying unit according to the previous embodiment, wherein the first heat exchange element is adapted to maintain the temperature of the sorption means below 150° C., preferably from about 50 up to 100° C.

3. The drying unit according to any one of embodiments 1 to 2, further comprising:
a temperature device adapted to measure a temperature of the sorption means;
a control unit adapted to regulate the temperature of the sorption means based on the temperature measured by the temperature device.

4. The drying unit according to any one of embodiments 1 to 3, further comprising:
a humidity device adapted to measure the water content of the second stream of air (104)
a control unit adapted to regulate the temperature of the sorption means (100) based on the measured water content of said second stream of air (104).

5. The drying unit according to any one of embodiments 1 to 4, further comprising:
a valve unit adapted to regulate an inflow of a heat transfer fluid inside the first heat exchange element in response to the control unit.

6. The drying unit according to any one of embodiments 1 to 5, wherein said inorganic oxoacid and or its salt and water are phosphoric and/or polyphosphoric acid and have a mass percentage concentration of H₃PO₄, calculated as percentage of mass of H₃PO₄ (PA) over mass of polyphosphoric acid (PPA), is in the range from about 85 to 110%, preferably 95 to 105%.

7. The drying unit according to any one of embodiments 1 to 6, further comprising a separation unit configured to clean impurities from the sorption means.

8. The drying unit according to any one of embodiments 1 to 7, wherein the sorption unit comprises:
a mixing unit, adapted to mix the first stream of air with the sorption means;
a sorption unit base, adapted to collect for example under the effect of gravity the consumed sorption means.

9. The drying unit according to embodiment 8, wherein the entrainment means is a coalescing droplet separation unit.

10. The drying unit according to any of embodiments 1 to 9, further comprising regeneration means comprising:
a second heat exchange element adapted to exchange heat with consumed sorption means, thereby providing regenerated sorption means, for example by causing evaporation of water from said consumed sorption means so to recuperate sorption means which can be reused for their sorption properties.
an economiser providing said sorption means in counterflow with consumed sorption means, so that sorption means to be regenerated can be preheated.

11. The drying unit according to any one of embodiments 1 to 10, further comprising contacting means connected to said sorption unit, wherein the contacting means are adapted to provide the second stream of air, therefore dried air, to said substance.

12. The drying unit according to any one of embodiments 1 to 11, wherein said substance is a product of the food and/or beverage industry.

13. The drying unit according to any one of embodiments 1 to 12, wherein the sorption unit is at least partially comprising acid resistant material provided to be in contact with the sorption means, wherein said material is selected from: carbon impregnated graphite, phenol impregnated graphite, silicium carbide (SiC) stainless steel or corrosion resistance metal alloys alloy S28, alloy G30, alloy S30, alloy G35.

14. Use of a drying unit as defined in any of embodiments 1 to 13, for the drying of a substance.

15. A method of drying a substance performed by the unit according to embodiment 1 to 13, the method comprising the steps of:
(a) providing a first stream of air having water content W₁;
(b) contacting said first stream of air having water content W₁ with sorption means, the sorption means comprising inorganic oxoacid and/or its salt and water;
(c) obtaining a second stream of air having water content W₂, wherein W₂<W₁, thereby providing consumed sorption means;
(d) contacting said second stream with said substance thereby direct drying said substance, and further comprising the step of:
(e) regenerating sorption means from consumed sorption means by heating.

16. The method of drying a substance according to embodiment 15, wherein at step (b), the inorganic oxoacid and/or its salt and water are preferably polyphosphoric acid and/or highly concentrated phosphoric acid.

17. The method of drying a substance according to embodiment 16, wherein said polyphosphoric acid and/or highly concentrated phosphoric acid have a mass percentage concentration of H₃PO₄ (PA/PPA) in the range from about 85 to 110%, more preferably 95 to 105%.

18. The method of drying a substance according to any one of embodiments 15 to 17, wherein at step (e), the sorption means are regenerated continuously.

19. The method of drying a substance according to any one of embodiments 15 to 18, wherein at step (b), the sorption means is provided during sorption at a temperature below 150° C., preferably from about 50 up to 100° C.

### BRIEF DESCRIPTION OF THE DRAWINGS

With specific reference now to the figures, it is stressed that the particulars shown are by way of example and for purposes of illustrative discussion of the different embodiments of the present invention only. They are presented in the cause of providing what is believed to be the most useful and readily description of the principles and conceptual aspects of the invention. In this regard, no attempt is made to show structural details of the invention in more detail than is necessary for a fundamental understanding of the invention. The description, taken with the drawings, makes apparent to those skilled in the art how the several forms of the invention may be embodied in practice.

FIG. 1, also abbreviated as FIG. 1, schematically illustrates a drying unit in accordance with 30 the present invention.

FIG. 2, also abbreviates as FIG. 2, illustrates a specific embodiment of the present invention wherein the sorption unit comprises a mixing unit and a sorption unit base.

FIG. 3, also abbreviated as FIG. 3, illustrates a Mollier diagram the relationship between air temperature, moisture content and enthalpy for the system described in an example of the present invention.

### DETAILED DESCRIPTION OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

When describing the compounds of the invention, the terms used are to be construed in accordance with the following definitions, unless a context dictates otherwise.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

As used in the specification and the appended claims, the singular forms “a”, “an”, and “the” include plural referents unless the context clearly dictates otherwise. By way of example, “a substance” means one substance or more than one substance.

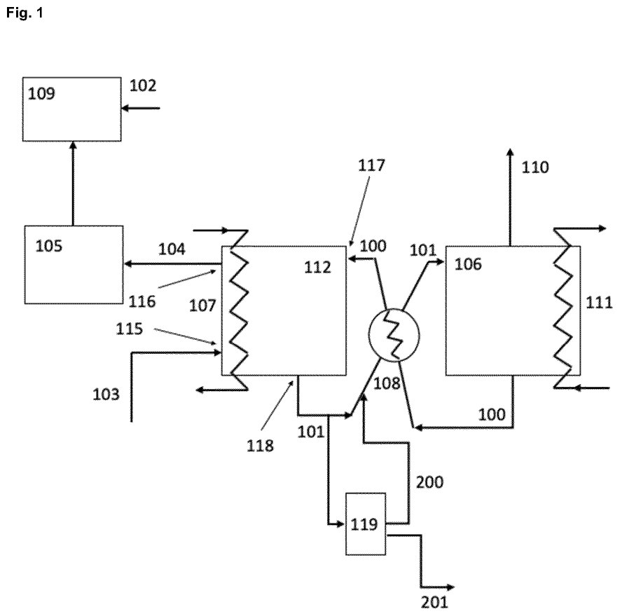

FIG. 1 illustrates a drying unit in accordance with the present invention. FIG. 1 illustrates a drying unit for drying a substance (102). The drying unit (102) comprises a sorption unit (112) and sorption means (100). The sorption unit (112) has a first inlet (115) adapted to receive a first stream of air (103) having water content W₁, and a first outlet (116) adapted to exit a second stream of air (104) having water content W₂, wherein W₂<W₁. The first stream of air is therefore relatively moist compared to the second stream of air (104), which is relatively dry compared to the first stream of air (103).

In the context of the present invention, by means of the term “water content”, or humidity, reference is made to the concentration of water vapour present in the air.

Therefore, by means of the present drying unit air is dried. Further, the sorption unit comprises a second inlet (117) adapted to receive sorption means (100), and a second outlet (118) adapted to exit consumed sorption means (101).

In the context of the present invention, by means of the term “sorption means”, or sorbent, reference is made to a substance or composition that is capable of sorption of a liquid or gas, e.g. water, water vapour.

In the context of the present invention, by means of the term “consumed sorption means” reference is made to sorption means which uptake capacity of a liquid or gas has been reduced compared to their original state, so that they have to be replaced or regenerated with sorption means with higher uptake capacity.

The first stream of air (103), also referred to as moist stream of air, or moist air, is dried by means of the sorption means that sorb water contained in said air stream and get consumed by said water, providing for sorption means that are not suitable anymore to be used to sorb water, having lost their efficacy at drying. Therefore, the sorption unit (112) provides for sorption means (100), which sorb water and then get consumed. Therefore, in other words, in operation the sorption means (100) sorb water from the first stream of air (103), or moist air, and providing the second stream of air (104), or dry air.

Moreover, said sorption means (100) contained in said sorption unit (112) comprise an inorganic oxoacid and/or its salt and water. For example, suitable inorganic oxoacids have chemical formula of type HₘXOₙ, where X is an atom functioning as a central atom, whereas parameters m and n depend on the oxidation state of the element X, such as, but not limited to, H₂SO₄, H₃PO₄ . . . .

In accordance with a preferred embodiment of the present invention, said inorganic oxoacid and or its salt and water are phosphoric and/or polyphosphoric acid. In a further embodiment, said phosphoric and/or polyphosphoric acid and have a mass percentage concentration of H₃PO₄ (PA/PPA) in the range from about 85 to 110%, preferably 95 to 105%. An advantage of concentrations according to the present embodiment is that the required drying needs and power can be achieved.

In accordance with a further embodiment of the present invention, the sorption unit (112) is at least partially comprising acid resistant material provided to be in contact with the sorption means (100), wherein said material is selected from: carbon impregnated graphite, phenol impregnated graphite, silicium carbide (SiC) stainless steel or corrosion resistance metal alloys alloy S28, alloy G30, alloy S30, alloy G35.

Further, the drying unit in accordance with the present invention further comprises a first heat exchange element (107) adapted to exchange heat with the sorption means (100). An advantage of having a first heat exchange element (107) according to the present embodiment is that the temperature of the sorption means can be more easily controlled. As a result, the dried air stream (104) can be controlled on dryness and temperature which is a great benefit when exposing to the substance (102), the more as the temperature of the dry stream (104) can be kept much lower when compared to existing drying installations. Therefore, in accordance with the present invention, the drying of said substance (102) can be drastically improved on drying efficiency and capacity, via dryness and temperature of the dry stream (104), without affecting the quality of said substance, by controlling the temperature of stream (104) so to not be detrimental to the substance (102), all this in an advantageous continuous operation. A drying unit in accordance with the present invention provides dry air (104) having humidity lower than the humidity of e.g. the surrounded atmospheric air of a first stream of air (103).

In the context of the present invention, by means of the term “heat exchange element” reference is made to a system capable of transferring heat between two entities, e.g. material and substance, water and air etc.

The first heat exchange element (107) can be a tower with packing, plates, and a heat exchange element with plates which can be incorporated in the tower but can also be heat exchanger tubes incorporated in said tower. The presence of a first heats exchange element (107) is important as it allows to control the desorption temperature of the sorption means (100).

In accordance with an embodiment of the present invention, the first heat exchange element (107) is adapted to maintain the temperature of the sorption means (100) below 150° C., preferably from about 50 up to 100° C. The control of the temperature of the sorption means below 150° C., preferably from about 50 up to 100° C., is advantageous for several reasons. First, it has been seen that higher temperatures can be detrimental to the quality of the substance to be dried. By keeping the temperature of the sorption means below 150° C., the stream of dry air (104) can be directly exposed to the substance to be dried. Further, it has been found that by keeping the temperature of the sorption means above 50° C., a sufficient drying force can be provided. The use of a temperature of the sorption means below 50° C. is possible, but the driving force provided might not be sufficient in some case scenarios.

Further, it has been found that by keeping the temperature of the sorption means below 150° C., preferably below 100° C., the temperature of the consumed sorption means (101) contained inside the regeneration means (106) can be kept below 230° C., below a critical level, wherein the drying unit become less efficient and additional heat exchanger might be needed to keep the temperature below 230° C.

In this way, the temperature of the consumed sorption means (101) can be more efficiently regulated in light of the water content of said sorption means (100) and the composition of said sorption means (100). For example, the temperature of the consumed sorption means (101) in the regeneration means (106) can be in this way controlled.

In accordance of an embodiment of the present invention, and as illustrated in FIG. 1, the sorption unit (112) is connected to regeneration means (106).

In the context of the present invention, by means of the term “regeneration means” reference is made to means adapted to provide a substance or composition anew, or in a physical and/or chemical state allowing said substance to retain its original functionality or part of it. In the context of the present invention, regeneration means regenerate sorption means so to provide from sorption means not possessing sorption properties, sorption means having their original sorption properties.

In accordance with this embodiment, the drying unit further comprises regeneration means (106) comprising: a second heat exchange element (111) adapted to exchange heat with consumed sorption means (101), thereby providing regenerated sorption means (100), and an economiser (108) providing said sorption means (100) in counterflow with consumed sorption means (101). Sorption means in accordance with the present invention can be for example regenerated by providing heat to said consumed sorption means (101). When the consumed sorption means (101) are heated in the regeneration means (106), water vapour (110) is generated. Ahead of the regeneration means (106), an economiser is present.

In the context of the present invention, by means of the term “economiser” reference is made to a device intended to reduce energy consumption e.g. by exchanging heat and pre-heating a fluid.

The economiser (108) in accordance with the present embodiment receives consumed sorption means (101) from the sorption unit (112), and exchanges heat between said consumed sorption means (101) and regenerated sorption means (100) coming from the regeneration means (106). In this way, consumed sorption means (101) are pre-heated before reaching the regeneration means (106), and regenerated sorption means (100) coming from the regeneration means (106) are cooled before reaching the sorption unit (112) to be used to sorb water from moist air.

It is best to separate sorption means (101) from clumps of sorption material or other impurities 35 that might be present. To avoid this, in accordance with a further embodiment of the present invention, the drying unit further comprises a separation unit configured to clean impurities from the sorption means. Impurities include but are not limited to solids (particles of any kind), liquids (droplets of any impure nature) and gases (foul gases, toxic compounds, . . . ).

In the context of the present invention, by means of the term “separation unit” reference is made to a unit capable of separating two or more entities or substances e.g. a filter.

The separation unit (119) can be position at various locations, so to possibly separate sorption means (100) or consumed sorption means (101) from impurities. Therefore, for example, the separation unit (119) rather than being disposed at the position in FIG. 1, therefore in between the second outlet (118) and the economiser (108), it could be disposed before the sorption means (100) enter the sorption unit (112), and therefore between the economiser (108) and the second inlet (117). The positioning of the separation can depend e.g. on the viscosity accepted by the type of filter used in the separation unit. The separation unit (119) can therefore separate impurities from usable sorption means (100) and provide the separated cleaned sorption means (200) back to the drying unit, and the filtrate (201) can then instead be disposed or sent to the water treatment plant.

As previously described, in accordance with the present invention the drying unit provides for a stream of dry air. Said stream of dry air can be used for drying a substance. In order to do so, the stream of dry air has to be contacted with said substance.

In the context of the present invention, by means of the term “substance” reference is made to any substance in any state or form, such as, but not limited to, pellets, construction materials, wood, gases, pulp and paper, drying of chemicals from synthesis reactions or inorganic and organic acid production, food. An advantage of the present invention is that it provides for air which is not contaminated by e.g. the sorption means (101) or heat exchange fluids. This allows for direct drying techniques to be used to dry said substance.

In accordance with an embodiment of the present invention, said substance (102) is a product of the food and/or beverage industry. The low contamination of dry air provided by present invention is advantageous for the drying of sensible products which need to comply with high quality standards and requirements.

In accordance with the present invention, the drying unit comprises entrainment means (105) connected to the sorption unit (112). The entrainment means (105) are adapted to receive the second stream of air (104), or dry air, and to separate entrained sorption means (100) from said second stream of air (104). In accordance with a further embodiment of the present invention, the entrainment means (105) is a coalescing droplet separation unit.

In accordance with a further embodiment of the present invention, the drying unit further comprises contacting means (109) connected to said sorption unit (112), wherein the contacting means are adapted to provide the second stream of air (104) in contact with said substance (102), so to dry said substance.

The present invention and its embodiments provide for the beneficial controlling of the drying process by means of the present invention. In accordance with a further embodiment of the present invention, the drying unit further comprises a temperature device adapted to measure a temperature of the sorption means (100), and a control unit adapted to regulate the temperature of the sorption means (100) based on the measured temperature. Further, in yet a further embodiment of the present invention, the drying unit further comprises a humidity device adapted to measure the water content of the second stream of air (104), and a control unit adapted to regulate the temperature of the sorption means (100) based on the measured water content of said second stream of air (104).

In the context of the present invention, by means of the term “temperature device” reference is made to a device provided with a temperature sensor which measures the temperature. In the context of the present invention, by means of the term “humidity device” reference is made to a device provided to measure a water content in the air, such as an hygrometer.

In the context of the present invention, by means of the term “control unit”, or processing unit, reference is made to a unit suitable for carrying out logical and arithmetical operations on data as specified in instructions provided to said control e.g. a CPU.

The temperature device and the control unit are used to/can be used to allow adjustment of the temperature of the sorption means (100), so that the temperature of the sorption means is kept under control, meaning within a desired temperature range. The control unit, connected to the temperature device is adapted to regulate the temperature of the sorption means (100) based on the measured temperature. The temperature of the sorption means is preferably regulated by the first heat exchange element, nevertheless, other means are possible. The temperature device is positioned at a location beneficial to measure the temperature of the sorption means (100), such as at the location of said stream of sorption means (100), before the sorption means (100) enter the sorption unit (112).

Further, the humidity device and the control unit are used to/can be used to allow adjustment of the water content of the stream of dried air, meaning the second stream of air (104). More specifically, whenever the second stream of dry air (104) is consider not dry enough for a specific application, the control unit connected to said humidity device provides for regulation of the temperature of the sorption means (100) inside the sorption unit (112), thus regulating the drying capacity in that unit. The temperature of the sorption means is preferably regulated by the first heat exchange element, nevertheless, other means are possible. This way the drying and temperature of the dried air can be adjusted.

In accordance with a further embodiment of the present invention, the drying unit further comprises a valve unit adapted to regulate an inflow of a heat transfer fluid, e.g. a coolant inside the first heat exchange element (107) in response to the control unit.

In the context of the present invention, by means of the term “valve unit” reference is made to a unit comprising means for controlling the flow of a liquid or a gas through a conduct or the like.

Coupled with the temperature device and the control unit, the valve unit can provide for the opening and closure of incoming streams and outcoming streams to and from the various parts of the drying unit of the present invention. For example, the valve unit can be used to define the amount of sorption means (100) entering the sorption unit (112) and thus controls the drying capacity in that unit. This way the drying and temperature of the dried air can be adjusted.

In accordance with the present invention and one or more of its embodiments and with reference to FIG. 1, the present invention provides for a method of drying a substance (102) performed by the drying unit according to the present invention, wherein the method comprises the steps of: (a) providing a first stream of air (103) having water content W₁. As depicted in FIG. 1, said first stream of air (103), also referred to as moist air, can be provided to the sorption unit (112) for example by means of the first inlet (115). Prior to this step, said moist air could have optionally undertaken a filtration step to remove pollutants or bigger particles. Further, inside the sorption unit (112) the step (b) of contacting said first stream of air (103) with sorption means (100) takes place. The sorption means (100) used can comprise inorganic oxoacid and/or its salt and water. Further, in step (c) a second stream of air (104) having water content W₂, wherein W₂<W₁, also referred to as dry air is obtained, thereby providing consumed sorption means (101). In a subsequent step (d), said second stream of air (104) is contacted with a substance (102) thereby direct drying said substance (102). Further, the step (e) of regenerating sorption means (100) from consumed sorption means (101) by heating takes place.

In accordance with a further embodiment of the present invention, at step (b), the inorganic oxoacid and/or its salt and water are preferably polyphosphoric acid and/or highly concentrated phosphoric acid.

In accordance with a further embodiment of the present invention, said polyphosphoric acid and/or highly concentrated phosphoric acid have a mass percentage concentration of H₃PO₄ (PA/PPA) in the range from about 85 to 110%, more preferably 95 to 105%. An advantage of concentrations according to the present embodiment is that the required drying needs and power can be achieved.

In accordance with a further embodiment of the present invention, at step (e) the sorption means (100) are regenerated continuously. In this way, the drying of air does not have to be interrupted for example to replace consumed sorption means (101) with new sorption means (100). The drying unit according to the present invention if capable of providing a continuous functioning, can be used in flow production lines, wherein it is beneficial to not stop production e.g. because sensitive material is involved or it is too laborious to halt the production and restart it, due to high power required for this step or other reasons.

In accordance with a further embodiment of the present invention, at step (b) the sorption means (100) is provided during sorption at a temperature below 150° C., preferably from about 50 up to 100° C. It has been found that keeping the temperature of the sorption means (100) below 150° C., preferably from about 50 up to 100° C., is beneficial for several reasons. First, it has been seen that higher temperatures can be detrimental to the quality of the substance to be dried. By keeping the temperature of the sorption means below 150° C., the stream of dry air (104) can be directly exposed to the substance to be dried. Further, it has been found that by keeping the temperature of the sorption means above 50° C., a sufficient drying force can be provided. The use of a temperature of the sorption means below 50° C. is possible, but the driving force provided might not be sufficient in some case scenarios.

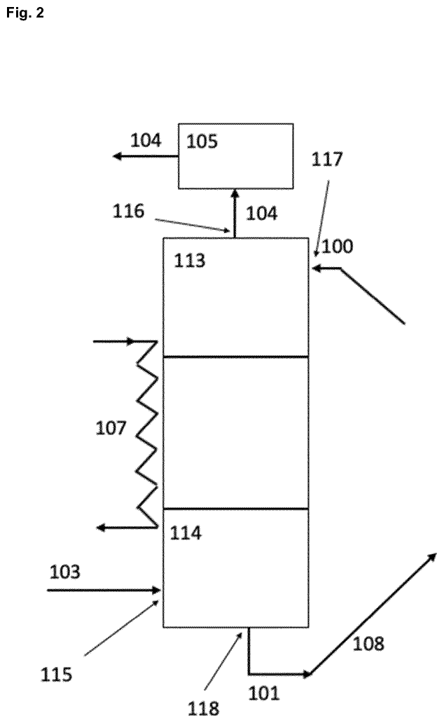

FIG. 2 illustrates a further embodiment of the present invention wherein the sorption unit (112) comprises a mixing unit (113) and a sorption unit base (114). In accordance this embodiment of the present invention, the sorption unit (112) comprises: a mixing unit (113), adapted to mix the first stream of air (103), entering the sorption unit (112) with the sorption means (100); and a sorption unit base (114), adapted to collect the consumed sorption means (101).

In the context of the present invention, by means of the term “mixing unit” reference is made to a unit capable of increasing the surface contact between two entities e.g. two liquids, one liquid and a solid etc. In other words, the mixing unit can be a mixer.

In the context of the present invention, by means of the term “sorption unit base” reference is made to a lower portion of the sorption unit, wherein liquids and/or solids tend to collect by means of gravitational forces. In other words, reference is made to the bottom of the sorption unit.

For example, in accordance with the present invention and one or more of its embodiments and with reference to FIG. 2, the sorption units that can be used in the context of the present invention can be for example an open packed bed reactor, wherein the mixing unit (113) is represented by a nozzle or other apparatus that allows for the sorption means (100) to better enter into contact with the stream of moist air. In this sorption unit (112), the water present in the stream of moist air is retained by the sorption means (100). In case the sorption means (100) are polyphosphoric acid and/or highly concentrated phosphoric acid, said sorption means (100) get enriched with water until they do not function anymore as a sorbant and have to be replaced. A stream of moist air can be provided to the sorption unit from any location allowing for the sorption of water to take place, preferentially from the sorption unit base (114), wherein said stream of moist air is provided to enter a first inlet (115). Sorption means (100) enters the mixing unit (113) through a second inlet (117), either from an economiser (108), a regeneration means (106) and/or from an external stream of active sorption means (100). After entering the mixing unit (113), the sorption means (100) are closely contacted inside the sorption unit (112) with moist air. A packed bed inside the sorption unit (112) allows for sufficient contacting of the stream of moist air with said sorption means (100), which fall to the sorption unit base (114) by means of gravity. At the time the sorption means (100) is collected to the sorption unit base (114), the sorption means is diluted by the water sorbed, meaning that consumed sorption means (101) are formed and collected at said sorption unit base (114). Therefore, consumed sorption means (101) after having retained water, is collected in the lower portion of the bed reactor, where said means are for example pumped out of the sorption unit (112) from the second outlet (118) to be disposed or regenerated. At the upper portion of the sorption unit (112), the stream of dry air obtained is exited from a first outlet (116).

In accordance with a second aspect, the present invention relates to the use of a drying unit as described in the embodiment of the present invention for the drying of a substance (102). In particular, the drying unit can be used in several industrial field and for different manufacturing methods requiring a drying step. For example, drying units according to the present invention can be used in any industry where a stable dry hot stream of air is the preferred drying means of the process substance, such as the food industry, beverage industry, pulp and paper industry, chemical industry, fine chemicals industry, pharmaceutical industry, agricultural industry, gases industry, wood industry . . . More specifically, the drying unit according to the present invention can be used for example by means for the drying of pellets, construction materials, wood, gases, pulp and paper, chemicals from synthesis reactions or inorganic and organic acid production, drying of super absorbent polymers e.g. from acrylic acid.

### Example

A 100 kW drying unit system according to the present invention has been set up in accordance with the present invention. The present exemplified system provides beside improve energy efficiency, that the drying velocity of substances to be dried, e.g. wet food substances is increased significantly. Moreover, the liquid sorption entrainment was kept at acceptable ppm level by means of a liquid droplet separation unit. The drying unit uses PPA as a liquid sorption medium. By means of the present drying unit the drying velocity of a food dryer process was increased significantly by keeping the liquid PPA below 100° C. during the absorption of water from a stream of moist air. By means of the drying unit of the present example, the drying velocity has been significantly increased by operating as sorption means PPA/PA and water, acting as a sorbent/desorbent at temperatures up to 100° C. as at these lower temperatures the water vapor pressure of the sorbent is much lower. It has been found that the driving force of the process, being the difference of the vapor pressure of water in air with the water vapor pressure in the sorbent, is much higher at lower sorbent temperatures. Despite a lower heat recuperation of lower air exhaust temperatures, the air is dried substantially, giving rise to a faster drying cycle.

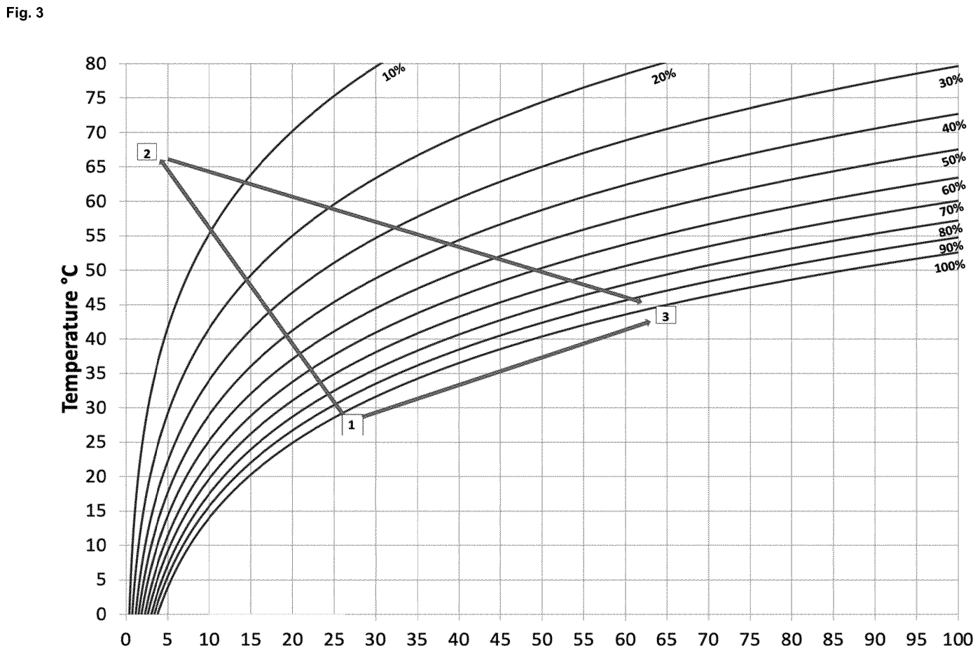

The performance of the drying technology according to the present invention can be presented by means of a Moller Diagram (FIG. 3). In the example given, two drying cycli are depicted that can occur in unit 109. One (from 1 to 2 to 3) represents the use of the sorption technology according to the invention. The other one (from 1 to 3) depicts existing technology. Point 1 represents an example air available in a process which is represented as stream 103 when applying the sorption technology and stream 102 when not. Point 2 represents an example air stream as output of unit 112 and depicted as stream 104 when applying the sorption unit. Point 3 represents an example air stream as output out of unit 109 where drying of a substance occurs. Current technology (arrow 1 to 3) can be read as following: Point 1 represents an example air stream (f.e. atmospheric air) represented as stream 102. In case the sorption unit is not considered and so stream 104 is not available, the incoming air of stream 102 will need to be exposed to an additional heating source to have the same final temperature as represented by Point 3. In order to achieve this, the air needs to be exposed to heat elements of 100 degrees Celsius and higher, which can cause harm to the substance dried. In order to achieve acceptable temperatures both heating and than cooling are required to provide an acceptable temperature of the air stream 102 when no sorption unit is used. Additionally, more volume of stream 102 will be needed since the absolute moisture content difference in between stream 102 and 104 is significant. This graphical example showcases that without the sorption unit, an additional heating source is required to lift the temperature of stream 102 and significantly more drying force is required for obtaining the same outcome (Point 3).

More specifically, the Mollier diagram in FIG. 3 represents the saturation curves of water in air. Here below are illustrated by means of a FIG. 3 two drying cycles, a first drying cycle A, and a second drying cycle B.

Drying cycle A is a drying cycle achievable by means of the drying unit in accordance with the present invention, whereas drying cycle B is a drying cycle that can be achieved by means of technology in the state of the art.

States 1, 2 and 3 in FIG. 3 represent states of air characterized by a specific temperature expressed in degree Celsius (° C.), and moisture content, expressed in grams of water vapor per kilogram of air (g/Kg).

Cycle A—State 1 to State 2 to State 3

The present drying cycle can be achieved by means of the drying unit of the present invention, wherein atmospheric air at state 1 (point 1), is characterized by relatively low Temperature and moisture content approximately a temperature of 27° C., and moisture content of 26 g/Kg. In light of the present invention, air in state 1 corresponds to stream 103. Further, the stream of air, after being dried by means of the sorption unit 112, is at state 2 (point 2), characterized by a much lower moisture content of approximately 2.5 g/Kg and a higher temperature of approximately 67° C. The dry air at state 2 is then utilized to dry a substance, such as food. The drying of food provides an air stream as output state 3 (point 3) out of unit 109 where drying of a substance

Cycle B (State of the Art)—State 1 to State 3

The present drying cycle represent the state of the art, wherein atmospheric air at state 1, characterized by relatively low Temperature and moisture content approximately a temperature of 30° C., and moisture content of 25 g/Kg. In the absence of a sorption unit, the air at state 1 will need to be exposed to an additional heating source so to provide the final temperature at state 3. In order to achieve this, the air needs to be exposed to heat elements of 100 degrees Celsius and higher, which can cause harm to the substance dried. In order to achieve an acceptable temperature, in the present case both a heating step and further 30 cooling step are required to provide an acceptable temperature of the air stream. Additionally, a larger volume of air will be needed since the absolute moisture content difference between the moisture content of the initial air stream, and the moisture content of the final air stream, is significant.

FIG. 3, and Cycle A and Cycle B thereby described, illustrates some of the advantages of the unit according to the present invention. More specifically, without the present invention, an additional heating source is required to lift the temperature of the initial air stream and significantly more drying force is required for obtaining the same outcome (Point 3).

During the summer, air intake is typically at 20 to 30° C. and 50 to 65% humidity, the recuperated and dried air from the system described here is typically from 15 to 30% humidity. As air intake is constant during the year, the production capacity is much lower compared to winter conditions. This unique new combination of increased drying velocity on average year basis and increased energy efficiency compared to a solely gas fueled system makes this system a viable industrial application. Further, the system was provided with a coalescing droplet separation unit to keep the entrainment of PA below food threshold PA concentrations. Based on Western Europe climatological circumstances the capacity increase is estimated at around 10 to 30% on a yearly basis for a food drying installation.

### LEGEND

100 Sorption means
101 Consumed sorption means
102 Substance
103 First stream of air having water content W₁
104 Second stream of air having water content W₂
105 Entrainment means
106 Regeneration means
107 First heat exchange element
108 Economiser
109 Contacting means
110 Water vapour
111 Second heat exchange element
112 Sorption unit
113 Mixing unit
114 Sorption unit base
115 First inlet
116 First outlet
117 Second inlet
118 Second outlet
119 Separation unit
200 Cleaned sorption means
201 Filtrate

1. A drying unit for drying a substance (102) comprising:
a sorption unit (112) having a first inlet (115) adapted to receive a first stream of air (103) having water content W₁, a first outlet (116) adapted to exit a second stream of air (104) having water content W₂, wherein W₂<W₁, a second inlet (117) adapted to receive sorption means (100), and a second outlet (118) adapted to exit consumed sorption means (101);
sorption means (100) contained in said sorption unit (112), the sorption means (100) comprising an inorganic oxoacid and/or its salt and water,
wherein in operation the sorption means (100) sorb water from the first stream of air (103), providing the second stream of air (104), wherein the drying unit further comprises:
a first heat exchange element (107) adapted to exchange heat with the sorption means (100); and
entrainment means (105) connected to the sorption unit (112), the entrainment means (105) adapted to receive the second stream of air (104) and to separate entrained sorption means from said second stream of air (104).

2. The drying unit according to the previous claim, wherein the first heat exchange element 107 is adapted to maintain the temperature of the sorption means (100) below 150° C., preferably from about 50 up to 100° C.

3. The drying unit according to any one of claims 1 to 2, further comprising:
a temperature device adapted to measure a temperature of the sorption means (100);
a control unit adapted to regulate the temperature of the sorption means (100) based on the measured temperature.

4. The drying unit according to any one of claims 1 to 3, further comprising:
a humidity device adapted to measure the water content of the second stream of air (104)
a control unit adapted to regulate the temperature of the sorption means (100) based on the measured water content of said second stream of air (104).

5. The drying unit according to any one of claims 1 to 4, further comprising:
a valve unit adapted to regulate an inflow of a heat transfer fluid inside the first heat exchange element (107) in response to the control unit.

6. The drying unit according to any one of claims 1 to 5, wherein said inorganic oxoacid and/or its salt and water are phosphoric and/or polyphosphoric acid and have a mass percentage concentration of H₃PO₄ (PA/PPA) in the range from about 85 to 110%, preferably 95 to 105%.

7. The drying unit according to any one of claims 1 to 6, further comprising a separation unit configured to clean impurities from the sorption means.

8. The drying unit according to any one of claims 1 to 7, wherein the sorption unit (112) comprises:
a mixing unit (113), adapted to mix the stream of air (103) having water content W₁ entering the sorption unit (112) with the sorption means (100);
a sorption unit base (114), adapted to collect the consumed sorption means (101).

9. The drying unit according to claim 1, wherein the entrainment means (105) is a coalescing droplet separation unit.

10. The drying unit according to any of claims 1 to 9, further comprising regeneration means (106) comprising:
a second heat exchange element (111) adapted to exchange heat with consumed sorption means (101), thereby providing regenerated sorption means (100).
an economiser (108) providing said sorption means (100) in counterflow with consumed sorption means (101).

11. The drying unit according to any one of claims 1 to 10, further comprising contacting means (109) connected to said sorption unit (112), wherein the contacting means are adapted to provide the second stream of air (104) in contact with said substance (102).

12. The drying unit according to any one of claims 1 to 11, wherein said substance (102) is a product of the food and/or beverage industry.

13. The drying unit according to any one of claims 1 to 12, wherein the sorption unit (112) is at least partially comprising acid resistant material provided to be in contact with the sorption means (100), wherein said material is selected from: carbon impregnated graphite, phenol impregnated graphite, silicium carbide, stainless steel, corrosion resistance metal alloys, alloy S28, alloy G30, alloy S30, alloy G35.

14. Use of a drying unit as defined in any of claims 1 to 13, for the drying of a substance (102).

15. A method of drying a substance (102) performed by the unit according to claims 1 to 13, the method comprising the steps of:
(a) providing a first stream of air (103) having water content W₁;
(b) contacting said first stream of air (103) with sorption means (100), the sorption means (100) comprising inorganic oxoacid and/or its salt and water;
(c) obtaining a second stream of air (104) having water content W₂, wherein W₂<W₁, thereby providing consumed sorption means (101);
(d) contacting said second stream of air (104) with said substance (102) thereby direct drying said substance (102), and further comprising the step of:
(e) regenerating sorption means (100) from consumed sorption means (101) by heating.

16. The method of drying a substance (102) according to claim 15, wherein at step (b), the inorganic oxoacid and/or its salt and water are preferably polyphosphoric acid and/or highly concentrated phosphoric acid.

17. The method of drying a substance (102) according to claim 16, wherein said polyphosphoric acid and/or highly concentrated phosphoric acid have a mass percentage concentration of H₃PO₄ (PA/PPA) in the range from about 85 to 110%, more preferably 95 to 105%.

18. The method of drying a substance (102) according to any one of claims 15 to 17, wherein at step (e), the sorption means (100) are regenerated continuously.

19. The method of drying a substance (102) according to any one of claims 15 to 18, wherein at step (b), the sorption means (100) is provided during sorption at a temperature below 150° C., preferably from about 50 up to 100° C.
